(19) United States
(12) Patent Application Publication
(10) Pub. No.: US 2007/0067401 A1
(43) Pub. Date: Mar. 22, 2007

(54) Information processing apparatus, message sending method, and computer-readable recording medium

(75) Inventors: Kyoko Kamata, Kawasaki (JP); Izumi Shinbo, Kawasaki (JP); Hiroaki Kanbayashi, Kokubunji (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/386,793

(22) Filed: Mar. 23, 2006

(30) Foreign Application Priority Data
Sep. 20, 2005 (JP) 2005-272258

(51) Int. Cl. G06F 15/16

(52) U.S. Cl. 709/206

(57) ABSTRACT

An information processing apparatus capable of sending and receiving email messages includes a storage unit configured to store address book information relating to a user of the information processing apparatus, and to store transmission/reception information about the transmission and reception of email messages; a search-criterion setting unit configured to set search criteria for retrieving email addresses to which an email message is to be sent; a retrieving unit configured to retrieve email addresses from the transmission/reception information on the basis of the search criteria set by the search-criterion setting unit; and an email address selector configured to select email addresses included in the address book information from the retrieved email addresses.

### BACKGROUND OF THE INVENTION

1. Field of the Invention

The present invention relates to an apparatus capable of sending and receiving email messages and further to a method for sending email messages.

2. Description of the Related Art

To send an email message and the like to a particular destination by using a known information processing apparatus capable of sending and receiving email messages, the user normally types the destination email address by direct key operation, or selects the destination email address from address book data or the like. Direct key operation involves many actions particularly in the case where the user specifies multiple destinations. Even if address book data is provided, the user needs to retrieve necessary data from the address book data, and further to select destination email addresses from the retrieved data.

A problem here is that such processes are very cumbersome for the user to perform.

In particular, if the user has changed his/her unique information, such as an email address, it is often required to send a notice to multiple recipients registered in the address book. Specifying recipients' email addresses for sending such a notice is quite burdensome for the user.

To solve the problems described above, Japanese Patent Application Laid-Open No. 2003-52071 discloses a method for sending the same email message to multiple recipients all at once or sequentially, using an address book or a message transmission/reception history in an information processing apparatus capable of sending and receiving email messages.

However, the technique disclosed in Japanese Patent Application Laid-Open No. 2003-52071 involves a determination as to whether or not to send a message, all at once, to a plurality of email addresses included in the address book or in the message transmission/reception history. To select some of the plurality of email addresses as recipients of the message, the user needs to determine whether or not to send the message with respect to each of the email addresses. This is cumbersome particularly in the case where there are many email addresses to be handled.

Moreover, in the method described above, if destination email addresses are to be retrieved from the message transmission/reception history, email addresses that are not registered in the address book are also selected as the destinations. If the user does not delete unwanted email messages, such as advertisement messages and mistakenly received messages, from the message transmission/reception history, email addresses to which the user does not wish to send a message will be selected as the destinations.

### SUMMARY OF THE INVENTION

Accordingly, an object of the present invention is to solve the problems described above, and to reduce the operational burden of the user when sending email messages from an information processing apparatus capable of sending and receiving email messages.

According to one aspect of the present invention, an information processing apparatus capable of sending and receiving email messages includes a storage unit configured to store address book information relating to a user of the information processing apparatus, and to store transmission/reception information about the transmission and reception of email messages; a search-criterion setting unit configured to set search criteria for retrieving email addresses to which an email message is to be sent; a retrieving unit configured to retrieve email addresses from the transmission/reception information on the basis of the search criteria set by the search-criterion setting unit; and an email address selector configured to select email addresses included in the address book information from the retrieved email addresses.

According to another aspect of the present invention, the information processing apparatus further includes a message sending processor configured to determine whether the number of email addresses selected by the email address selector has exceeded a maximum number of email addresses to which a message can be sent at one time, and a message sending/receiving unit configured to assign the selected email addresses to multiple transmissions if it is determined that the number of selected email addresses has exceeded the maximum number of email addresses to which a message can be sent at one time.

According to another aspect of the present invention, the information processing apparatus further includes a message sending processor configured to allow the user to select whether to send a message to one or a plurality of email addresses selected by the email address selector, and further configured to determine whether the number of email addresses selected by the user has exceeded a maximum number of email addresses to which a message can be sent at one time, and a message sending/receiving unit configured to assign the selected email addresses to multiple transmissions if it is determined that the number of email addresses selected by the user has exceeded the maximum number of email addresses to which a message can be sent at one time.

According to another aspect of the present invention, a message sending method for sending an email message to multiple destinations includes a storing step of storing address book information relating to a user of an information processing apparatus for sending the email message, and storing transmission/reception information about the transmission and reception of email messages; a search-criterion setting step of setting search criteria for retrieving email addresses to which the email message is to be sent; a retrieving step of retrieving email addresses from the transmission/reception information on the basis of the search criteria set in the search-criterion setting step; and an email-address selecting step of selecting email addresses included in the address book information from the email addresses retrieved in the retrieving step.

According to another aspect of the present invention, a message sending program for sending an email message to multiple destinations has a computer execute a storing step of storing address book information relating to a user of an information processing apparatus for sending the email message, and storing transmission/reception information about the transmission and reception of email messages; a search-criterion setting step of setting search criteria for retrieving email addresses to which the email message is to be sent; a retrieving step of retrieving email addresses from the transmission/reception information on the basis of the search criteria set in the search-criterion setting step; and an email-address selecting step of selecting email addresses included in the address book information from the email addresses retrieved in the retrieving step.

Without having the user perform cumbersome operations, the present invention allows the user to retrieve only email addresses that satisfy the user's desired criteria from a large number of addresses registered in the address book, and enables the user to specify the retrieved email addresses as message destinations.

The present invention allows bulk message sending without having the user perform cumbersome operations with respect to retrieved email addresses, since a large number of email addresses can be specified as message destinations.

### BRIEF DESCRIPTION OF THE DRAWINGS

FIG. 1 is a block diagram showing the basic configuration of an information processing apparatus of the present invention.

FIG. 2 is a flowchart showing a process by which destination candidates are displayed.

FIG. 3 illustrates an exemplary display screen showing the email addresses of destination candidates.

FIG. 4 shows an exemplary search-criterion setting screen.

FIG. 5 is a flowchart showing the process of bulk message sending.

FIG. 6 shows exemplary address book information stored in a storage section 120.

FIG. 7A to FIG. 7D show exemplary history/count information stored in the storage section 120.

FIG. 8 shows an exemplary list of retrieved email addresses.

### DESCRIPTION OF THE PREFERRED EMBODIMENTS

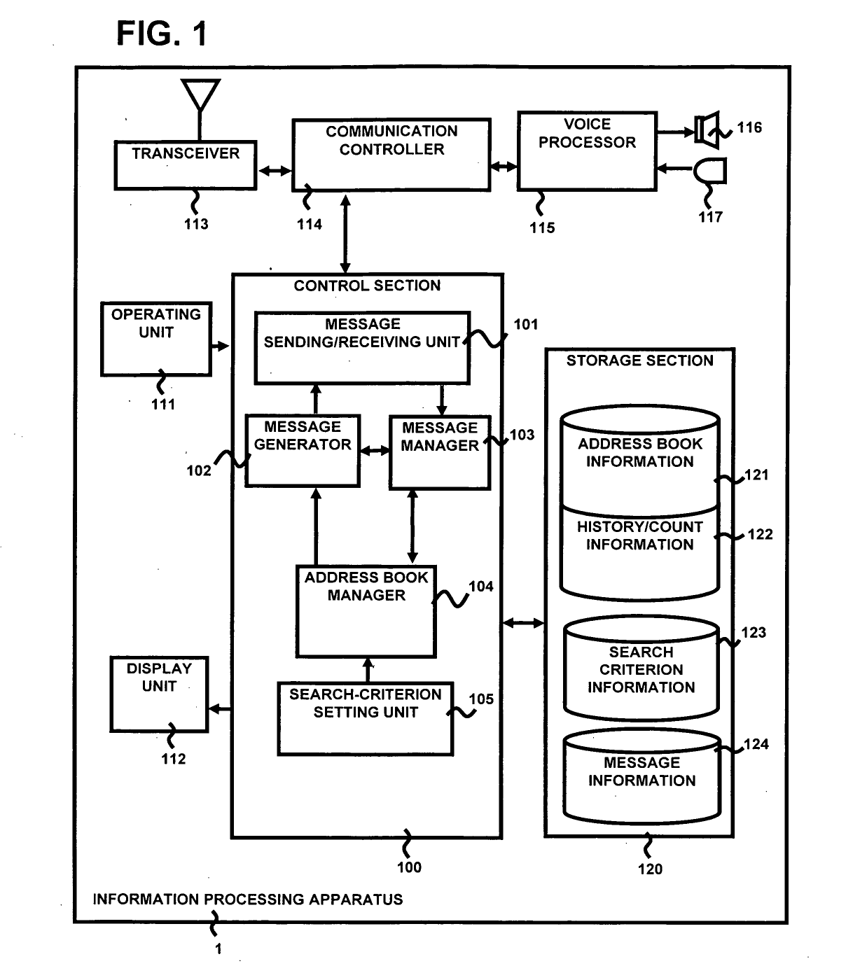

FIG. 1 is a block diagram showing the basic configuration of an information processing apparatus 1 of the present invention.

Examples of the information processing apparatus 1 include, but are not limited to, mobile phones, personal computers (PCs), and personal digital assistances (PDAs) that are capable of providing email capabilities. In the present embodiment, a mobile phone will be described as an example of the information processing apparatus 1 (hereinafter, the information processing apparatus 1 will be referred to as “mobile phone 1”).

Primarily, the mobile phone 1 includes a control section 100, an operating unit 111, a display unit 112, a transceiver 113, a communication controller 114, a voice processor 115, a speaker 116, a microphone 117, and a storage section 120.

The control section 100, including a central processing unit (CPU) with cache memory, performs predetermined information processing by executing a predetermined program stored on a hard disk. While email capabilities will only be described below in the present embodiment, the control section 100 performs program control operations, such as call control and camera control, on other applications on the mobile phone 1.

The control section 100 includes functional units, such as a message sending/receiving unit 101, a message generator 102, a message manager 103 (serving as a message sending processor), an address book manager 104 (serving both as a retrieving unit and an email address selector), and a search-criterion setting unit 105.

A user operates the operating unit 111 to set the criteria of email addresses the user wants to retrieve from address book information 121. The criteria are set in the search-criterion setting unit 105 on the basis of history/count information 122. The address book manager 104 is used to retrieve email addresses that match the search criteria specified in the search-criterion setting unit 105. The user operates the operating unit 111 to select some of the retrieved email addresses. The email addresses selected by the user are set as the destinations of an email message by the message generator 102. The message manager 103 monitors whether the number of set destination addresses has exceeded the specified maximum number of destinations to which a message can be sent at one time. If the specified maximum number has been exceeded, the destination addresses selected by the user are broken up and assigned to different transmissions. Messages generated by the message generator 102 are sent, via the transceiver 113, by the message sending/receiving unit 101.

The operating unit 111 includes, for example, a numeric keypad, a talk key, a clearing key, function keys, and an arrow key. The user uses the operating unit 111 to enter phone numbers and email addresses, and to call and operate each function of the mobile phone 1.

The display unit 112 includes, for example, a liquid crystal display (LCD) device, and displays various types of input and output information with respect to the control section 100.

The communication controller 114 modulates a carrier signal with call signals, dial signals, or the like, and performs demodulation as well. The transceiver 113 sends and/or receives radio signal waves via an antenna.

The voice processor 115 is connected to the speaker 116 and to the microphone 117. The voice processor 115 converts analog voice signals received from the microphone 117 into digital signals, and converts digital voice signals outputted from the control section 100 into analog signals. The speaker 116 is used to reproduce voice signals outputted from the control section 100 and to reproduce voice signals received from the microphone 117.

The storage section 120 stores the address book information 121, the history/count information 122, search criterion information 123, and the message information 124 that are read by the control section 100. The storage section 120 also stores data obtained, via the transceiver 113, from other mobile phones and the like. The storage section 120 is constituted, for example, by a flash memory that can maintain data after the power is turned off.

The address book information 121 stored in the storage section 120 includes the phone numbers, email addresses, and residential addresses of friends and colleagues of the user of the mobile phone 1, and is information contained, for example, in a so-called address book. The information included in the address book information 121 may be organized by person, shop, company, or the like, or may be organized according to other criteria.

The history/count information 122 is the history of email messages sent and received by the mobile phone 1, and is the history of incoming and outgoing calls. Each destination address is associated with the time at which an email message was sent to the destination, and each source address is associated with the time at which an email message was received from the source. Similarly, each destination phone number is associated with the time of an outgoing call to the destination, and each source phone number is associated with the time of an incoming call from the source.

The information described above is further associated with the numbers of times an email message was sent to the destination address and received from the source address, and with the numbers of outgoing calls to the destination phone number and incoming calls from the source phone number. These numbers are counted by the control section 100. The history/count information 122 further includes email message bodies received by the mobile phone 1 from other mobile phones, and email message bodies sent by the mobile phone 1 to other mobile phones. In other words, the history/count information 122 includes information stored in the inbox, outbox, and save box of a typical mobile phone. Email message bodies may be stored separately from message history information, message count information, and the like.

The search criterion information 123 includes criterion information, such as “message was sent to/received from the address on Jun. 1, 2005 or later AND message was sent to/received from the address 10 times or more”, for the user to retrieve desired email addresses and the like from the address book information 121 that the user entered using the operating unit 111.

The message information 124 is information that the image processing system 100 has retrieved from the address book information 121 according to the search criterion information 123. For example, the message information 124 includes email message bodies to be sent, and a list of destination email addresses retrieved from the address book information 121.

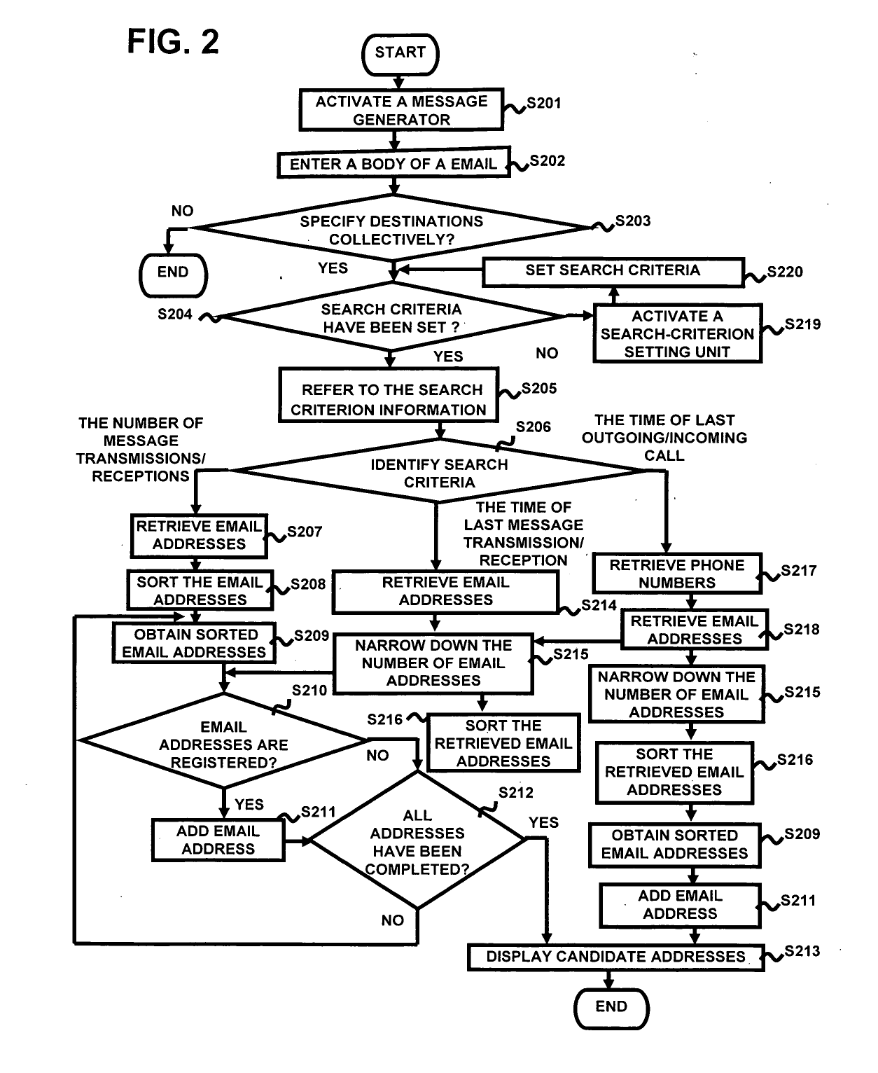

FIG. 2 is a flowchart showing a process by which destination candidates are displayed.

First, the user activates the message generator 102 to inform multiple people of, for example, a change in personal information, such as a mobile phone number or an email address (step S201). While the function keys of the operating unit 111 are often used to call the functions of the message generator 102, the user may use other methods to activate the message generator 102.

Then, the user types the body of the email message using, for example, the numeric keypad of the operating unit 111 (step S202). In addition to the entry of characters, the user may be able to attach images and video files to the message, and to decorate the massage using Deco-mail (registered trademark) functions supported by NTT DoCoMo's mobile phones.

After entering the body of the message, the user determines whether or not to collectively specify the destinations of the message (step S203). Specifically, the user operates the operating unit 111 to call the message manager 103, determines whether or not to collectively specify the message destinations, and allows the message manager 103 to control the subsequent processing. Collectively specifying the message destinations means that, instead of sending the message generated in step S202 to multiple people individually specified by the user, people such as those who satisfy predetermined criteria are automatically specified as the destinations, for example, on the basis of the determination of the control section 100.

If the user determines not to collectively specify the destinations of the message, the process of displaying destination candidates ends.

If the user determines to collectively specify the message destinations, the message manager 103 determines whether search criteria for determining the message destinations have already been set (step S204).

If it is determined by the message manager 103 that the search criteria have not been set yet, the search-criterion setting unit 105 is activated via the address book manager 104 (step S219). Then, after the user sets the search criteria using the operating unit 111 (step S220), the process returns to step S204, where it is determined whether or not the search criteria have already been set. The search criteria set in the search-criterion setting unit 105 are included in the search criterion information 123 in the storage section 120. The search criterion information 123 may either be overwritten or accumulated every time one or more search criteria are set in the search-criterion setting unit 105.

If it is determined in the message manager 103 that the search criteria have already been set, the message manager 103 refers to the search criterion information 123 in the storage section 120 (step S205).

Then, the message manager 103 identifies the search criteria set in the search criterion information 123 (step S206). The search criteria here are the number of message transmissions/receptions, the time of last message transmission/reception, and the time of last outgoing/incoming call. These search criteria may be replaced with others, or may be used independently or in conjunction with AND or OR operators.

If the number of message transmissions/receptions is set as a search criterion in the search criterion information 123, the address book manager 104 retrieves email addresses to or from which a message was sent or received more than or equal to the number of times set in the search criterion information 123, from the address book information 121 or from information stored in the inbox, outbox, and save box and included in the history/count information 122 (step S207).

Then, the address book manager 104 sorts the retrieved email addresses in order of the number of times an email message was sent or received (step S208). The number of message transmissions/receptions indicates the total of the number of message transmissions and the number of message receptions. The retrieved email addresses may be arranged in order of the number of message transmissions alone, or in order of the number of message receptions alone. In step S207, the number of message transmissions alone or the number of message receptions alone may be set as a search criterion. In this case, from the address book information 121 or from information stored in the inbox, outbox, and save box and included in the history/count information 122, the address book manager 104 retrieves email addresses to which a message was sent by the number of times more than or equal the number of message transmissions set in the search criterion information 123, or retrieves email addresses from which a message was received by the number of times more than or equal to the number of message receptions set in the search criterion information 123.

Then, the retrieved and sorted email addresses are sequentially obtained by the message manager 103 and stored in the storage section 120 as a part of the message information 124 (step S209).

The address book manager 104 determines whether each of the retrieved email addresses is registered in the address book information 121 (step S210). If registered, the email address is added to the list of destination candidate addresses (step S211) and stored in the storage section 120 as a part of the message information 124. Then, it is determined whether the determinations as to the registration of all the retrieved email addresses in the address book information 121 have been completed (step S212). If the determinations as to the registration with respect to all the retrieved email addresses have been completed, the destination candidate addresses are displayed in the display unit 112 (step S213) and thus, the process of displaying destination candidate addresses ends. If the determinations as to the registration with respect to all the retrieved email addresses have not yet been completed, the process returns to step S209.

If it is determined in step S210 that a retrieved email address is not registered in the address book information 121, the email address is not added to the list of destination candidate addresses and the process proceeds to step S212. If it is determined in step S212 that the determinations as to the registration with respect to all the retrieved email addresses have been completed, destination candidate addresses previously obtained are displayed in the display unit 112 (step S213) and the process of displaying destination candidate addresses ends. If it is determined in step S212 that the determinations as to the registration with respect to all the retrieved email addresses have not yet been completed, the process returns to step S209.

Similarly, if it is determined in step S206 that the time of last message transmission/reception is set as a search criterion in the search criterion information 123, the address book manager 104 retrieves email addresses to or from which a message was sent or received at or after the time set in the search criterion information 123, from the address book information 121 or from information stored in the inbox, outbox, and save box and included in the history/count information 122 (step S214) and narrows down the number of email addresses (step S215).

In the step of narrowing down the number of email addresses (step S215), for example, it is determined which of email messages (i.e., sent messages, received messages, or both sent and received messages) corresponding to the retrieved email addresses are to be targeted. In the present embodiment, only the received messages are targeted to narrow down the number of email addresses.

Then, the address book manager 104 sorts the retrieved email addresses by the time of message reception in reverse chronological order (step S216).

The retrieved and sorted email addresses are sequentially obtained by the message manager 103 and stored in the storage section 120 as a part of the message information 124 (step S209).

The address book manager 104 determines whether each of the retrieved email addresses is registered in the address book information 121 (step S210). If registered, the email address is added to the list of destination candidate addresses (step S211) and stored in the storage section 120 as a part of the message information 124. Then, it is determined whether the determinations as to the registration of all the retrieved email addresses in the address book information 121 have been completed (step S212). If the determinations as to the registration with respect to all the retrieved email addresses have been completed, the destination candidate addresses are displayed in the display unit 112 (step S213) and thus, the process of displaying destination candidate addresses ends. If the determinations as to the registration with respect to all the retrieved email addresses have not yet been completed, the process returns to step S209.

If it is determined in step S210 that a retrieved email address is not registered in the address book information 121, the email address is not added to the list of destination candidate addresses and the process proceeds to step S212. If it is determined in step S212 that the determinations as to the registration with respect to all the retrieved email addresses have been completed, destination candidate addresses previously obtained are displayed in the display unit 112 (step S213) and the process of displaying destination candidate addresses ends. If it is determined in step S212 that the determinations as to the registration with respect to all the retrieved email addresses have not yet been completed, the process returns to step S209.

Similarly, if it is determined in step S206 that the time of last outgoing/incoming call is set as a search criterion in the search criterion information 123, the address book manager 104 retrieves phone numbers to or from which a call was sent or received at or after the time set in the search criterion information 123, from the address book information 121 or from an outgoing/incoming call history included in the history/count information 122 (step S217). Here, it is possible to determine which of phone numbers (i.e., the sources of incoming calls, the destinations of outgoing calls, or both the sources of incoming calls and the destinations of outgoing calls) are to be retrieved.

Then, the address book manager 104 retrieves the email addresses corresponding to the retrieved phone numbers from the address book information 121 (step S218) and narrows down the number of email addresses (step S215).

In the step of narrowing down the number of email addresses (step S215), for example, it is determined which of email messages (i.e., sent messages, received messages, or both sent and received messages) corresponding to the retrieved email addresses are to be targeted. In the present embodiment, only the received messages are targeted to narrow down the number of email addresses.

Then, the address book manager 104 sorts the retrieved email addresses by the time of message reception in reverse chronological order (step S216). The retrieved email addresses may be sorted by the time of incoming or outgoing call in reverse chronological order. The retrieved email addresses may also be sorted by the time of outgoing call or incoming call in reverse chronological order, by the time of outgoing call in reverse chronological order, or by the time of incoming call in reverse chronological order.

Then, the retrieved and sorted email addresses are sequentially obtained by the message manager 103 and stored in the storage section 120 as a part of the message information 124 (step S209).

The retrieved email addresses are added by the address book manager 104 to the list of destination candidate addresses (step S211) and stored in the storage section 120 as a part of the message information 124. Then, the destination candidate addresses are displayed in the display unit 112 (step S213) and thus, the process of displaying destination candidate addresses ends. If the determinations as to the registration with respect to all the retrieved addresses have not yet been completed, the process returns to step S209.

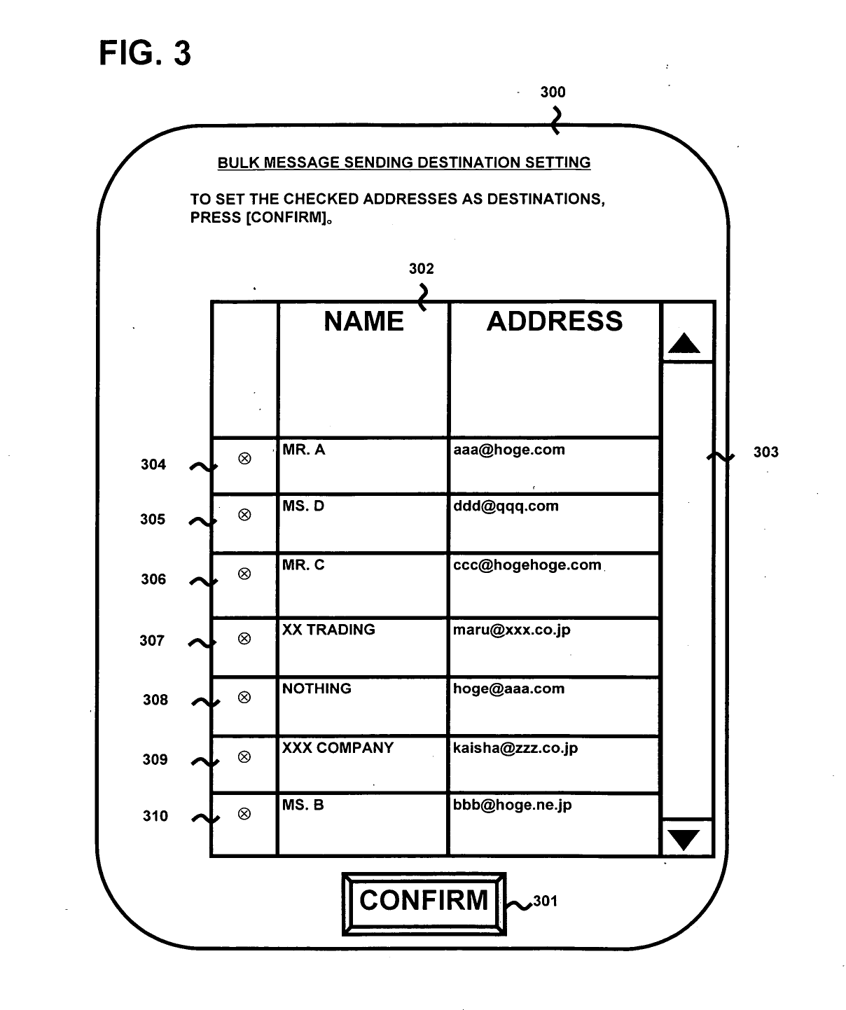

FIG. 3 illustrates an exemplary display screen showing the email addresses of destination candidates.

In step S213, a display screen 300 in the display unit 112 displays, at the top, a guidance message “To set the checked addresses as destinations, press [Confirm]”. A Confirm button 301 for setting message destinations is provided at the bottom of the display screen 300.

A list of destination candidate addresses is displayed in the center of-the display screen 300. In the present embodiment, destination candidate addresses are displayed in tabular form. The left column provides the user with circular checkboxes 304 to 310 for selecting destinations to which an email message is to be sent. The middle column provides registered names corresponding to respective destination candidate addresses and registered in the address book. The right column provides the destination candidate addresses. The user can scroll up and down the list of destination candidate addresses by using a scroll bar 303 if the entire list cannot be displayed on the display screen 300.

The Confirm button 301, the circular checkboxes 304 to 310, and the scroll bar 303 may be configured to be operated with the operating unit 111, or operated through the display unit 112 provided in the form of a touch panel.

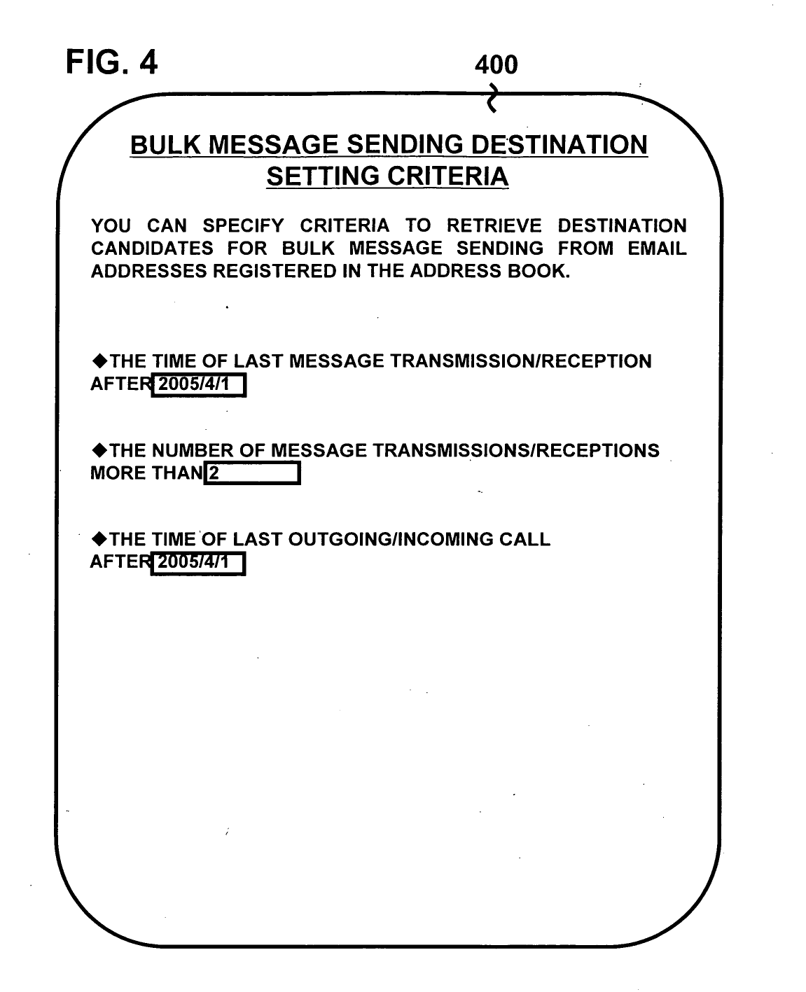

FIG. 4 shows an exemplary search-criterion setting screen for setting search criteria in the search-criterion setting unit 105.

A display screen 400 displays, at the top, a guidance message “You can specify criteria to retrieve destination candidates for bulk message sending from email addresses registered in the address book”.

The message on the display screen 400 is followed by three search criteria, that is, the time of last message transmission/reception, the number of message transmissions/receptions, and the time of last outgoing/incoming call. The user can specify the values of these criteria by using the operating unit 111. Not all of these search criteria have to be specified. Email addresses are retrieved on the basis of specified criteria combined with AND operators. Therefore, in order to retrieve email addresses meeting a single criterion such as the time of last message transmission/reception, other criteria, that is, the number of message transmissions/receptions, and the time of last outgoing/incoming call are left undefined. Alternatively, the search-criterion setting unit 105 may be configured such that a set value option, such as “None”, can be specified.

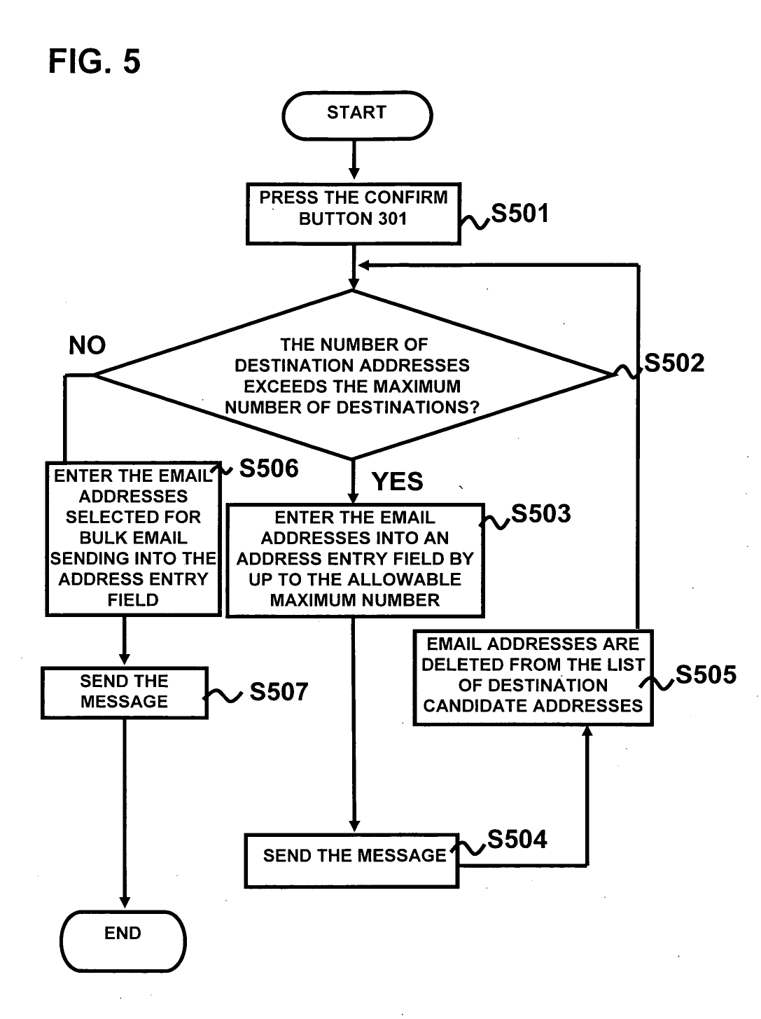

FIG. 5 is a flowchart showing the process of bulk message sending.

First, the user presses the Confirm button 301 on the display screen 300 for bulk message sending to checked email addresses on the list (step S501). The Confirm button 301 may be pressed with the operating unit 111, or through the display unit 112 provided in the form of a touch panel.

Then, the message manager 103 determines whether the number of destination addresses selected for bulk email sending exceeds the maximum number of destinations allowable in a single message transmission (step S502).

If the allowable maximum number is exceeded, the user enters the email addresses into an address entry field by up to the allowable maximum number, thereby specifying these email addresses as destinations (step S503).

After the message sending by the message sending/receiving unit 101 (step S504), these email addresses are deleted from the list of destination candidate addresses (step S505). Then, the process returns to step S502, where the message manager 103 determines again whether the number of destination addresses selected for bulk email sending exceeds the maximum number of destinations allowable in a single message transmission.

If the allowable maximum number is not exceeded, the user enters the email addresses selected for bulk email sending into the address entry field, thereby specifying these email addresses as destinations (step S506). Then, an email message is sent to the email addresses by the message sending/receiving unit 101 and the process of bulk message sending ends (step S507).

Time required for bulk email sending is shorter than that required in the case where a message is individually sent to each email address. This can contribute to the reduced cost of email transmission.

Finally, an exemplary data configuration for a variety of information stored in the storage section 120 will be described below.

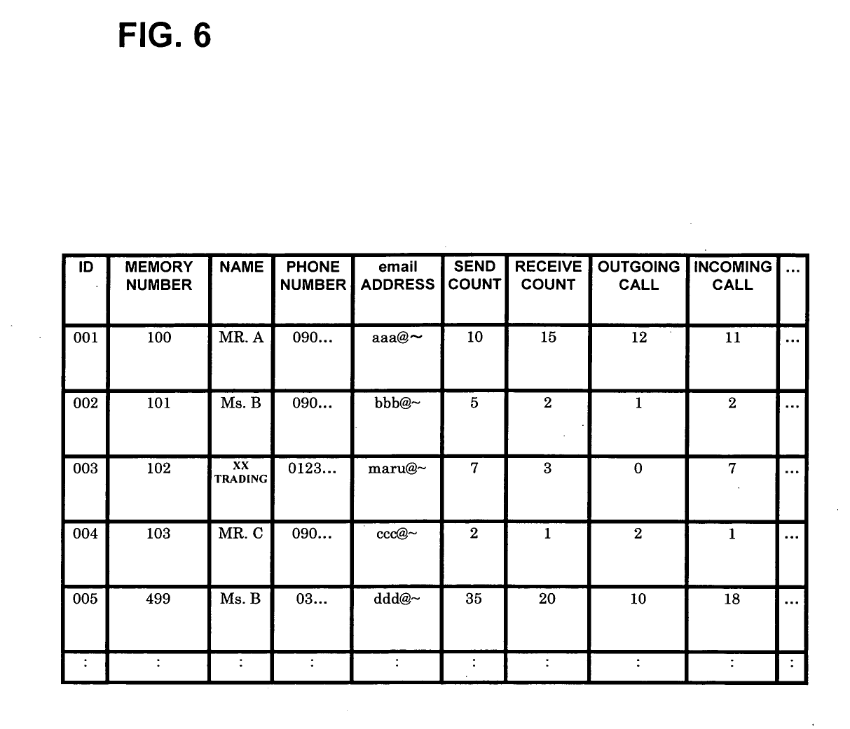

FIG. 6 shows an exemplary data configuration for the address book information 121.

In this example, the address book information 121 is displayed in tabular form. As shown in FIG. 6, the address book information 121 in the storage section 120 includes ID, memory number, registered name, phone number, email address, send count (i.e., the number of times the user sent a message to the corresponding email address), receive count (i.e., the number of times the user received a message from the corresponding email address), outgoing call (i.e., the number of outgoing calls to the corresponding phone number from the user), and incoming call (i.e., the number of incoming calls from the corresponding phone number to the user). In FIG. 6, each phone number is abbreviated as “090 . . . ”, and each email address is abbreviated as “aaa@˜”.

In addition, the address book information 121 may include such information as the address, domicile, and ZIP code of each of Mr. A and Ms. B. Furthermore, for example, the land-line phone number and facsimile number (if any) of Mr. A may also be included. The same applies to Ms. B, XX Trading, Mr. C, and Ms. D. Information associated with the above-described send count, receive count, outgoing call, and incoming call may be included only in the history/count information 122 and may be omitted from the address book information 121.

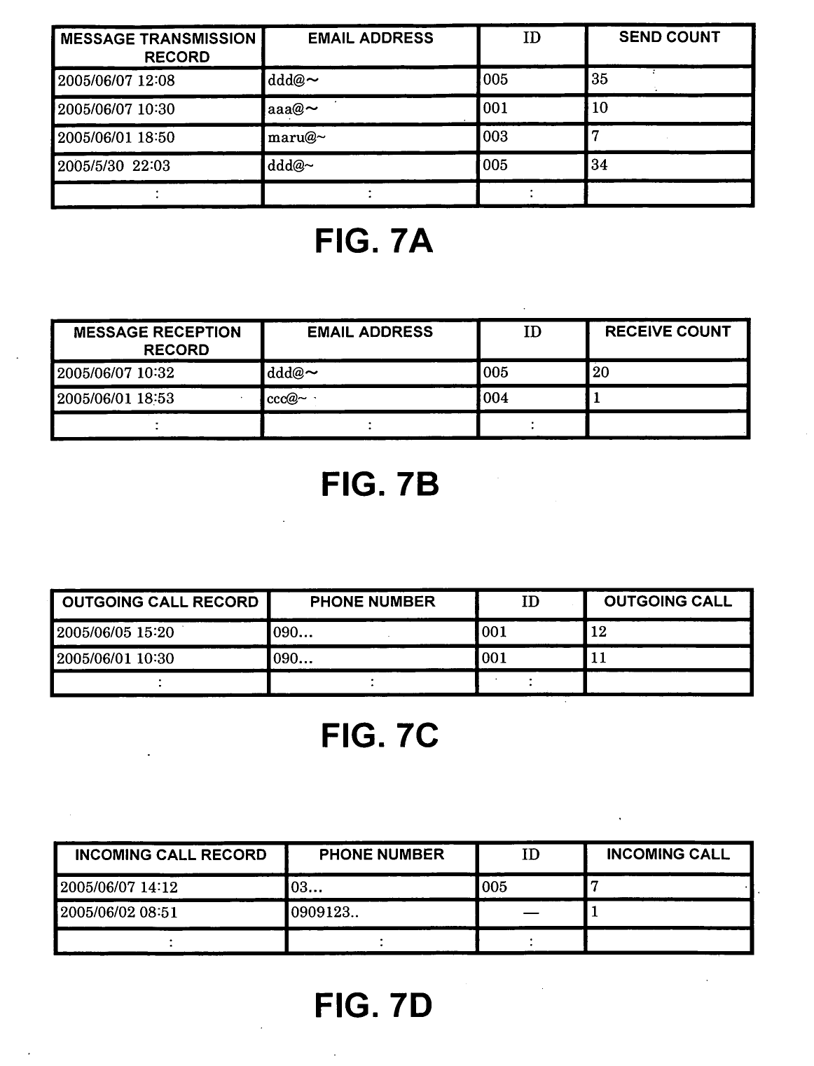

FIG. 7A to FIG. 7D show exemplary data configurations for the history/count information 122.

FIG. 7A shows message transmission records, FIG. 7B shows message reception records, FIG. 7C shows outgoing call records, and FIG. 7D shows incoming call records.

In the present embodiment, the message transmission records in FIG. 7A are sorted in reverse chronological order (from top to bottom) according to the time at which the user received a message from the corresponding address. However, the message transmission records may be sorted according to different criteria. For example, they may be sorted in ascending order (from top to bottom) according to ID number.

Similarly, the message reception records in FIG. 7B are sorted in reverse chronological order (from top to bottom) according to the time at which the user received a message from the corresponding address; the outgoing call records in FIG. 7C are sorted in reverse chronological order (from top to bottom) according to the time at which the user made a call to the corresponding phone number; and the incoming call records in FIG. 7D are sorted in reverse chronological order (from top to bottom) according to the time at which the user received a call from the corresponding phone number. These records may also be sorted in different orders.

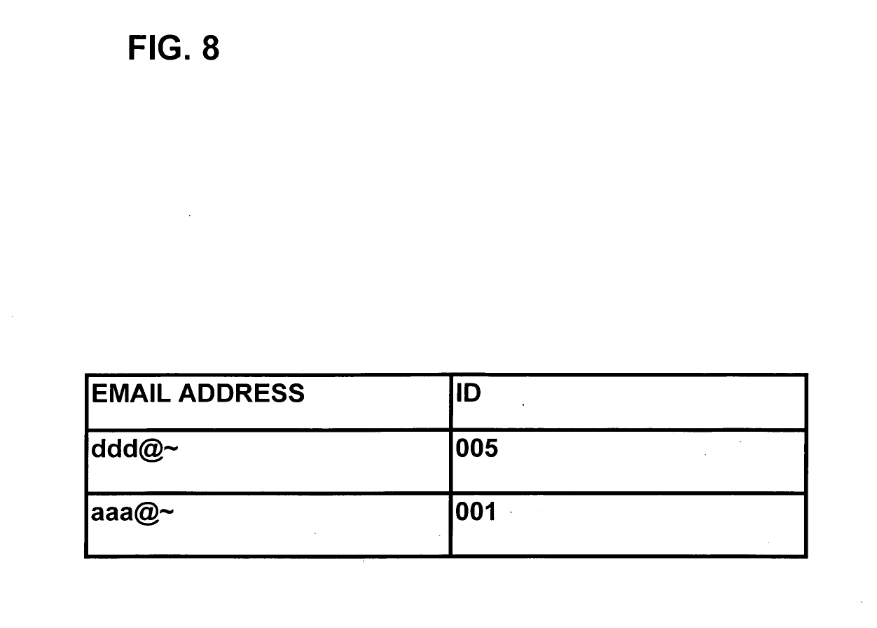

FIG. 8 shows an exemplary list of email addresses retrieved according to certain criteria.

Information retrieved by the address book manager 104 is stored in the storage section 120 as a part of the message information 124.

In the present embodiment, email addresses “aaa@˜” and “ddd@˜” are retrieved according to the criteria, such as “message was sent to/received from the address on Jun. 1, 2005 or later AND message was sent to/received from the address 10 times or more”.

These retrieved email addresses are displayed as destination candidates on the display unit 112 as shown in FIG. 3.

The characteristics, advantages, and modifications of each of the above embodiments will now be described.

(1) In the above embodiments, a mobile phone has been described as an example of the information processing apparatus. However, the present invention is not limited to the mobile phone, and may also be applicable to other information processing apparatuses capable of providing email capabilities.

(2) In the embodiments described above, email addresses are retrieved according to certain criteria, such as the time of message transmission/reception, the time of outgoing/incoming call, and the number of message transmissions/receptions. However, the present invention is not limited to such criteria. For example, email addresses may be retrieved according to the type of carrier used.

(3) In the embodiments described above, after the retrieval of some email addresses according to the time of last message transmission/reception and the time of last outgoing/incoming call, the number of retrieved email addresses are further narrowed down by focusing only on sent email messages or on received email messages. However, the present invention is not limited to this. Email addresses may be retrieved, for example, on the basis only of sent email messages or of received email messages, from the beginning of the retrieval.

(4) In the embodiments described above, in FIG. 3, email addresses of destination candidates are displayed in tabular form. However, the present invention is not limited to this form, and registered names do not have to appear on the display screen 300. Moreover, the email addresses do not have to be provided with the circular checkboxes 304 to 310 that allow the user to perform selection. The circular checkboxes 304 to 310 may be configured such that the user can uncheck the individual circular checkboxes 304 to 310 that are all checked by default, or such that the user can check the individual circular checkboxes 304 to 310 that are all unchecked by default.

Technical ideas underlying the above-described embodiments of the information processing apparatus are set forth in the appended claims. Technical ideas of the present invention can be understood variously and at different levels ranging from upper-level concepts to lower-level concepts. The present invention is not to be considered limited to what is described above.

What is claimed is:

1. An information processing apparatus comprising:
a storage unit storing address book information relating to a user of the information processing apparatus, and transmission/reception information concerning the transmission and reception of email messages;
a search-criterion setting unit setting search criteria for retrieving email addresses to which an email message is to be sent;
a retrieving unit retrieving email addresses from the transmission/reception information on the basis of the search criteria set by the search-criterion setting unit; and
an email address selector selecting email addresses included in the address book information from the retrieved email addresses.

2. The information processing apparatus according to claim 1, wherein the transmission/reception information includes at least one of a message transmission/reception history of the information processing apparatus, an outgoing/incoming call history of the information processing apparatus, and the number of times a message was sent to/received from a particular email address by the information processing apparatus; and
the search-criterion setting unit sets search criteria for retrieving email addresses by referring to at least one of the message transmission/reception history of the information processing apparatus, the outgoing/incoming call history of the information processing apparatus, and the number of times a message was sent to/received from a particular email address by the information processing apparatus.

3. The information processing apparatus according to claim 1, further comprising:
a message sending processor determining whether the number of email addresses selected by the email address selector has exceeded a maximum number of email addresses to which a message can be sent at one time; and
a message sending/receiving unit dividing the plurality of selected email-addresses into a plurality of address groups, the message sending/receiving unit assigning the plurality of email-addresses included in each of the plurality of the plurality of address groups to one of a plurality of duplicated messages, and the message sending/receiving unit sending each of the plurality of duplicated messages to the assigned email addresses when it is determined that the number of selected email addresses has exceeded the maximum number of email addresses to which a message can be sent at one time.

4. The information processing apparatus according to claim 1, further comprising:
a message sending processor allowing the user to select whether to send a message to one or a plurality of email addresses selected by the email address selector, and further configured to determine whether the number of email addresses selected by the user has exceeded a maximum number of email addresses to which a message can be sent at one time; and
a message sending/receiving unit dividing the plurality of selected email-addresses into a plurality of address groups, the message sending/receiving unit assigning the plurality of email-addresses included in each of the plurality of the plurality of address groups to one of a plurality of duplicated messages, and the message sending/receiving unit sending each of the plurality of duplicated messages to the assigned email addresses when it is determined that the number of email addresses selected by the user has exceeded the maximum number of email addresses to which a message can be sent at one time.

5. A message sending method for sending an email message to multiple destinations, executed by programmed processor, the message sending method comprising the steps of:
storing address book information relating to a user of an information processing apparatus for sending the email message, and storing transmission/reception information concerning the transmission and reception of email messages;
setting search criteria for retrieving email addresses to which the email message is to be sent
retrieving email addresses from the transmission/reception information on the basis of the search criteria set in the search-criterion setting step; and
selecting email addresses included in the address book information from the email addresses retrieved in the retrieving step.

6. The message sending method according to claim 5, further comprising the steps of:
determining whether the number of selected email addresses has exceeded a maximum number of email addresses to which a message can be sent at one time; and
dividing the plurality of selected email-addresses into a plurality of address groups, assigning the plurality of email-addresses included in each of the plurality of the plurality of address groups to one of a plurality of duplicated messages, and sending each of the plurality of duplicated messages to the assigned email addresses when it is determined that the number of selected email addresses has exceeded the maximum number of email addresses to which a message can be sent at one time.

7. A computer-readable recording medium that stores a computer program for sending an email message to multiple destinations and having a computer execute:
a storing step of storing address book information relating to a user of an information processing apparatus for sending the email message, and storing transmission/reception information concerning the transmission and reception of email messages;
a search-criterion setting step of setting search criteria for retrieving email addresses to which the email message is to be sent;
a retrieving step of retrieving email addresses from the transmission/reception information on the basis of the search criteria set in the search-criterion setting step; and
an email-address selecting step of selecting email addresses included in the address book information from the email addresses retrieved in the retrieving step.

8. A computer-readable recording medium according to claim 7, having the computer further execute:
a message transmission processing step of determining whether the number of selected email addresses has exceeded a maximum number of email addresses to which a message can be sent at one time; and
a message sending/receiving step of dividing the plurality of selected email-addresses into a plurality of address groups, assigning the plurality of email-addresses included in each of the plurality of the plurality of address groups to one of a plurality of duplicated messages, and sending each of the plurality of duplicated messages to the assigned email addresses when it is determined that the number of selected email addresses has exceeded the maximum number of email addresses to which a message can be sent at one time.

9. A computer-readable recording medium according to claim 7, having the computer further execute:
a message transmission processing step of allowing the user to select whether to send a message to one or a plurality of email addresses selected in the email-address selecting step, and of determining whether the number of email addresses selected by the user has exceeded a maximum number of email addresses to which a message can be sent at one time; and
a message sending/receiving step of dividing the plurality of selected email-addresses into a plurality of address groups, assigning the plurality of email-addresses included in each of the plurality of the plurality of address groups to one of a plurality of duplicated messages, and sending each of the plurality of duplicated messages to the assigned email addresses when it is determined that the number of the email addresses selected by the user has exceeded the maximum number of email addresses to which a message can be sent at one time.
